(19) United States
(12) Patent Application Publication
(10) Pub. No.: US 2024/0105179 A1
(43) Pub. Date: Mar. 28, 2024

(54) VOICE-CONTROLLED AI-BASED VEHICLE-MOUNTED DISPLAY SYSTEM AND CONTROL METHOD

(71) Applicant: Jianhui Lin, Puning (CN)

(72) Inventor: Jianhui Lin, Puning (CN)

(21) Appl. No.: 18/536,494

(22) Filed: Dec. 12, 2023

(51) Int. Cl. G10L 15/22

(52) U.S. Cl. CPC G10L 15/22; G10L 2015/223

(57) ABSTRACT

Disclosed is a voice-controlled AI-based vehicle-mounted display system, and the system includes an RX control terminal. The RX control terminal includes a host circuit board, a voice acquisition module, a voice chip, a receiving terminal MCU chip, and a display module, where the receiving terminal MCU chip is provided with a storage module, a plurality of sets of voice instructions are stored in the storage module, and each set of voice instructions corresponds to a control instruction. Further, the voice acquisition module is configured to collect and transmit audio signals to the voice chip, the voice chip converts a received audio signal into a digital instruction signal and sends it to the receiving terminal MCU chip, and the receiving terminal MCU chip compares and matches the received instruction with an original voice instruction stored in the storage module, and outputs a corresponding control instruction according to matching results.

### TECHNICAL FIELD

The present disclosure relates to the technical field of display driving for data cables, and particularly relates to a voice-controlled AI-based vehicle-mounted display system and a control method.

### BACKGROUND

A vehicle-mounted display, by means of connection to a camera, is capable to receive and display images captured by the camera, which makes it easy for a driver to observe road conditions and reverse. Further, the vehicle-mounted display is capable to display a running state of a vehicle, a navigation screen, audio and video information, various built-in APP pages, etc., which can enhance safety of vehicle driving and an effect of displaying videos captured.

However, many vehicle-mounted displays need to be manually operated and controlled, thus resulting in inconvenience of operation. Moreover, when a driver manually operates a vehicle-mounted display in the driving process, the driver is undoubtedly exposed to a higher risk of driving safety.

### SUMMARY

An objective of the present disclosure is to provide a voice-controlled AI-based vehicle-mounted display system and a control method, so as to overcome the problems that the existing vehicle-mounted display systems need to be manually operated and controlled, thus resulting in inconvenience of operation, and the driver is undoubtedly exposed to a higher risk of driving safety when manually operating a vehicle-mounted display in the driving process.

In order to achieve the above objective, the present disclosure, in an aspect, provides a voice-controlled AI-based vehicle-mounted display system, and the system includes an RX control terminal. The RX control terminal includes a host circuit board, a voice acquisition module, a voice chip, a receiving terminal MCU chip, and a display module, where the receiving terminal MCU chip is integrated on the host circuit board, the display module is electrically connected to the host circuit board, and the voice acquisition module is in communication connection with the receiving terminal MCU chip by means of the voice chip. The receiving terminal MCU chip is provided with a storage module, the storage module is provided with an original voice instruction storage module, a plurality of sets of original voice instructions are stored in the original voice instruction storage module, and each set of original voice instructions corresponds to a control instruction. The voice acquisition module is configured to collect and transmit audio signals to the voice chip, the voice chip converts a received audio signal into a digital instruction signal and sends it to the receiving terminal MCU chip, and the receiving terminal MCU chip compares and matches the received instruction with an original voice instruction stored in the storage module, and outputs a corresponding control instruction according to matching results.

Further, the RX control terminal further includes a key module, and the key module is electrically connected to the host circuit board and configured for manual control.

Further, the storage module of the receiving terminal MCU chip is further provided with a newly added voice instruction storage module, and the newly added voice instruction storage module is configured to store newly added voice instructions collected by a user by means of the voice acquisition module and control instructions corresponding to newly added voice instructions; and after receiving a digital instruction signal converted by the voice chip, the receiving terminal MCU chip compares and matches the received instruction with an original voice instruction and a newly added voice instruction stored in the storage module simultaneously, and outputs a corresponding control instruction according to matching results.

Further, a microphone is used for the voice acquisition module, and an LCD display screen or an LED display screen is used for the display module.

Further, the RX control terminal further includes a receiving terminal wireless connection chip, the receiving terminal wireless connection chip is electrically connected to the receiving terminal MCU chip, and the receiving terminal MCU chip is in communication connection with peripheral equipment by means of the receiving terminal wireless connection chip.

Further, one or more sets of TX terminals are further included, the TX terminal includes a control circuit board, a transmitting terminal MCU chip, a transmitting terminal wireless connection chip, a camera drive circuit, and a camera, where the transmitting terminal MCU chip, the transmitting terminal wireless connection chip, and the camera drive circuit are arranged on the control circuit board, the transmitting terminal MCU chip, by means of a transmitting terminal, is in communication connection with the receiving terminal wireless connection chip of the RX control terminal, and the camera is electrically connected to the transmitting terminal MCU chip by means of the camera drive circuit.

Further, the transmitting terminal MCU chip is provided with an H.264 video compression module, and the receiving terminal MCU chip is provided with an MGPEG video decoding module.

Further, the TX terminal further includes an infrared camera, and the infrared camera is electrically connected to the transmitting terminal MCU chip.

In a further aspect, the present disclosure provides a control method for a voice-controlled AI-based vehicle-mounted display system, and the control method is used for the above voice-controlled AI-based vehicle-mounted display system. The RX control terminal is provided with a code pairing key, and the TX terminal is provided with a code pairing mode and a code pairing LED lamp. The control method includes the following steps:
S100, powering on the RX control terminal, and powering on the display module of the RX control terminal for display;
S200, pressing and holding the code pairing key until the display module displays a word “Pairing” to enter the code pairing mode;
S300, powering on the TX terminal to enable the TX terminal to automatically enter the code pairing mode;
S400, flashing the code pairing LED lamp of the TX terminal for code pairing, where the RX control terminal, after successful code pairing, receives images captured by the TX terminal; and
S500, collecting and transmitting audio signals to the voice chip by means of the voice acquisition module, converting a received audio signal into a digital instruction signal by means of the voice chip and sending it to the receiving terminal MCU chip, comparing and matching the received instruction with a voice instruction stored in the storage module by means of the receiving terminal MCU chip, and outputting a corresponding control instruction according to matching results.

Further, voice trigger instructions are stored in the storage module of the receiving terminal MCU chip, and only when the receiving terminal MCU chip receives an instruction signal that matches a voice trigger instruction, a voice control mode can be activated.

Compared with the prior art, the present disclosure features the following beneficial effects:

1. The present disclosure has a voice control function, that is, only a corresponding voice instruction is required to operate the vehicle-mounted display system, without need of manual operation, thus not only improving the convenience of operation, but also enhancing safety of driving.

2. The transmitting terminal MCU chip of the present disclosure is provided with the H.264 video compression module capable of efficiently compressing images captured by the camera, the transmitting terminal MCU chip transmits a compressed video to the receiving terminal MCU chip in a manner of wireless signal transmission, and the receiving terminal MCU chip is provided with the MGPEG video decoding module capable of quickly reading and decoding the received compressed video and transmitting it to the display module for display; and arrangement of the H.264 video compression module and the MGPEG video decoding module makes the present disclosure be capable to efficiently transmit and display the images captured by the camera.

3. Voice trigger instructions are stored in the storage module of the receiving terminal MCU chip of the present disclosure, and only when the receiving terminal MCU chip receives an instruction signal that matches a voice trigger instruction, a voice control mode can be activated to effectively avoid the occurrence of any voice misoperation.

### BRIEF DESCRIPTION OF THE DRAWINGS

FIG. 1 is a block diagram of an electronic control structure of a voice-controlled AI-based vehicle-mounted display system provided by the present disclosure.

FIG. 2 is a block diagram of an electronic control structure of an RX control terminal of the voice-controlled AI-based vehicle-mounted display system provided by the present disclosure.

FIG. 3 is a block diagram of an electronic control structure of a TX terminal of the voice-controlled AI-based vehicle-mounted display system provided by the present disclosure.

FIG. 4 is a functional module diagram of a storage module of a receiving terminal MCU chip of the voice-controlled AI-based vehicle-mounted display system provided by the present disclosure.

### DETAILED DESCRIPTION OF THE EMBODIMENTS

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinary skill in the art, the specific meanings of the above terms in the present disclosure may be understood according to specific circumstances.

The present disclosure will be further described below with reference to the accompanying drawings and the specific embodiments.

### Embodiment 1

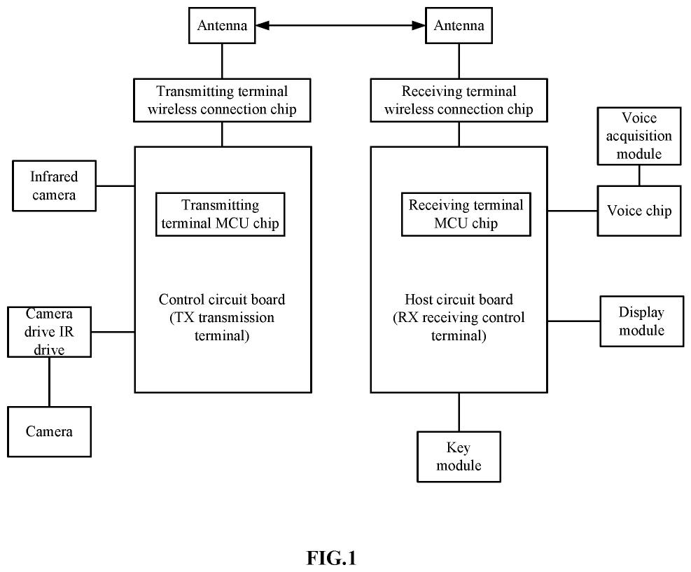

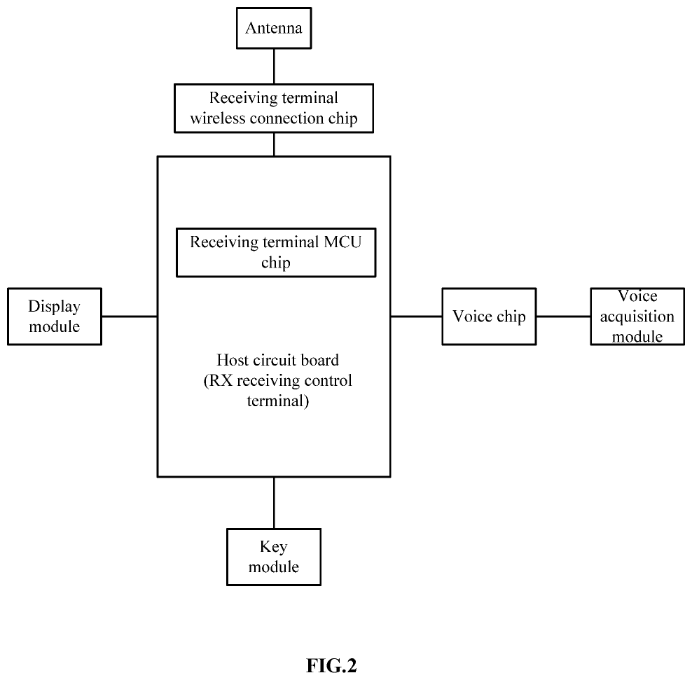

This embodiment provides a voice-controlled AI-based vehicle-mounted display system, and the system, as shown in FIGS. 1, 2, and 3, includes an RX control terminal and one or more sets of TX terminals. The TX terminal can be arranged at any desired positions such as the front, rear, roof, and both sides of a vehicle. The RX control terminal includes a host circuit board, a voice acquisition module, a voice chip, a receiving terminal MCU chip, and a display module, where a microphone is used for the voice acquisition module, and an LCD display screen or an LED display screen is used for the display module. The receiving terminal MCU chip is integrated on the host circuit board, and the display module is electrically connected to the host circuit board, and is configured to display a running state of a vehicle, a navigation screen, audio and video information, various built-in APP pages, etc. The voice acquisition module is in communication connection with the receiving terminal MCU chip by means of the voice chip. The receiving terminal MCU chip is provided with a storage module, the storage module is provided with an original voice instruction storage module, a plurality of sets of original voice instructions are stored in the original voice instruction storage module, and each set of original voice instructions corresponds to a control instruction. The voice acquisition module is configured to collect and transmit audio signals to the voice chip, the voice chip converts a received audio signal into a digital instruction signal and sends it to the receiving terminal MCU chip, and the receiving terminal MCU chip compares and matches the received instruction with an original voice instruction stored in the storage module, and outputs a corresponding control instruction according to matching results, such as an instruction of turning on, turning off, playing songs, opening or closing a certain APP, etc. The RX control terminal further includes a key module, and the key module is electrically connected to the host circuit board and configured for manual control.

In some exemplary embodiments, as shown in FIG. 4, the storage module of a certain receiving terminal MCU chip is further provided with a newly added voice instruction storage module, and the newly added voice instruction storage module is configured to store newly added voice instructions collected by a user by means of the voice acquisition module and control instructions corresponding to newly added voice instructions. After receiving a digital instruction signal converted by the voice chip, the receiving terminal MCU chip compares and matches the received instruction with an original voice instruction and a newly added voice instruction stored in the storage module simultaneously, and outputs a corresponding control instruction according to matching results. Such arrangement results in that users can customize voice instructions and record their own voices, and even users not proficient in Mandarin can operate conveniently.

In some exemplary embodiments, voice trigger instructions are stored in the storage module of the receiving terminal MCU chip, and only when the receiving terminal MCU chip receives an instruction signal that matches a voice trigger instruction, a voice control mode can be activated to effectively avoid the occurrence of any voice misoperation.

As shown in FIGS. 1, 2, and 3, the RX control terminal further includes a receiving terminal wireless connection chip, the receiving terminal wireless connection chip is electrically connected to the receiving terminal MCU chip, and the receiving terminal MCU chip is in communication connection with peripheral equipment by means of the receiving terminal wireless connection chip through Bluetooth signal transmission or WiFi signal transmission. The TX terminal includes a control circuit board, a transmitting terminal MCU chip, a transmitting terminal wireless connection chip, a camera drive circuit, and a camera, where the transmitting terminal MCU chip, the transmitting terminal wireless connection chip, and the camera drive circuit are arranged on the control circuit board, the transmitting terminal MCU chip, by means of a transmitting terminal, is in communication connection with the receiving terminal wireless connection chip of the RX control terminal, and the camera is electrically connected to the transmitting terminal MCU chip by means of the camera drive circuit. Images captured by the camera are first transmitted to the transmitting terminal MCU chip, and the transmitting terminal MCU chip is provided with an H.264 video compression module capable of efficiently compressing the images captured by the camera. The transmitting terminal MCU chip transmits a compressed video to the receiving terminal MCU chip in a manner of wireless signal transmission, and the receiving terminal MCU chip is provided with an MG PEG video decoding module capable of quickly reading and decoding the received compressed video and transmitting it to the display module for display. Arrangement of the H.264 video compression module and the MGPEG video decoding module results in that the images captured by the camera are efficiently transmitted and displayed.

Further, after the RX control terminal and the TX terminal are in communication connection, voice control of the TX terminal can also be performed to turn off or turn on a certain camera.

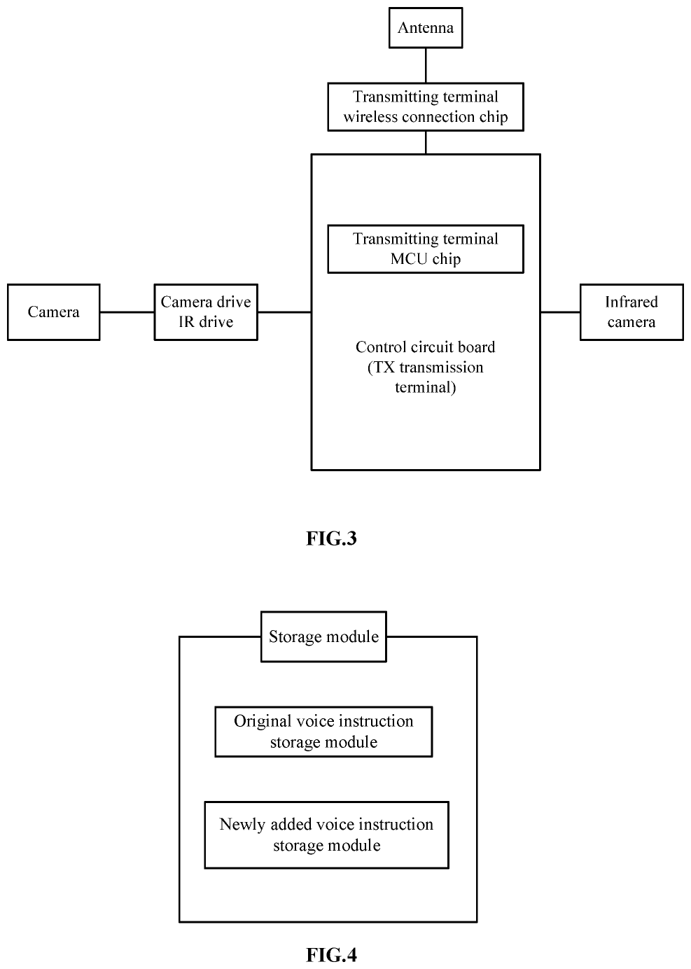

As shown in FIG. 3, in some exemplary embodiments, a certain TX terminal further includes an infrared camera, and the infrared camera is electrically connected to the transmitting terminal MCU chip. Arrangement of the infrared camera enables the vehicle-mounted display system to have a night vision function.

A working principle of the present disclosure: the present disclosure provides a voice acquisition module and a voice chip, where the voice acquisition module is in communication connection with the receiving terminal MCU chip by means of the voice chip, the receiving terminal MCU chip is provided with a storage module, a plurality of sets of voice instructions are stored in the storage module, and each set of voice instructions corresponds to a control instruction. The voice acquisition module is configured to collect and transmit audio signals to the voice chip, the voice chip converts a received audio signal into a digital instruction signal and sends it to the receiving terminal MCU chip, and the receiving terminal MCU chip compares and matches the received instruction with an original voice instruction stored in the storage module, and outputs a corresponding control instruction according to matching results. Therefore, the present disclosure has a voice control function, that is, only a corresponding voice instruction is required to operate the vehicle-mounted display system, without need of manual operation, thus not only improving the convenience of operation, but also enhancing safety of driving.

### Embodiment 2

A control method for a voice-controlled AI-based vehicle-mounted display system is used for the voice-controlled AI-based vehicle-mounted display system provided in Embodiment 1. An RX control terminal is provided with a code pairing key, and a TX terminal is provided with a code pairing mode and a code pairing LED lamp. The control method includes the following steps:
S100, the RX control terminal is powered on, and a display module of the RX control terminal is powered on for display;
S200, the code pairing key is pressed and held until the display module displays a word “Pairing” to enter the code pairing mode;
S300, the TX terminal is powered on to enable the TX terminal to automatically enter the code pairing mode;
S400, the code pairing LED lamp of the TX terminal flashes for code pairing, where the RX control terminal, after successful code pairing, receives images captured by the TX terminal, and the images can be displayed on the display module of the RX control terminal; and
S500, a voice acquisition module collects audio signals, and after a receiving terminal MCU chip receives an instruction signal that matches a voice trigger instruction, a voice control mode is activated to perform voice control of the RX control terminal and the TX terminal. After the voice control mode is activated, the voice acquisition module collects and transmits audio signals to a voice chip, the voice chip converts a received audio signal into a digital instruction signal and sends it to the receiving terminal MCU chip, and the receiving terminal MCU chip compares and matches the received instruction with a voice instruction stored in a storage module, and outputs a corresponding control instruction according to matching results.

The above descriptions are only preferred embodiments of the present disclosure and are not intended to limit the present disclosure, and various changes and modifications may be made to the present disclosure by those skilled in the art. Any modifications, equivalent substitutions, improvements, etc. within the spirit and principles of the present disclosure are intended to fall within the scope of protection of the present disclosure.

What is claimed is:

1. A voice-controlled AI-based vehicle-mounted display system, comprising an RX control terminal, wherein the RX control terminal comprises a host circuit board, a voice acquisition module, a voice chip, a receiving terminal MCU chip, and a display module, wherein the receiving terminal MCU chip is integrated on the host circuit board, the display module is electrically connected to the host circuit board, and the voice acquisition module is in communication connection with the receiving terminal MCU chip by means of the voice chip; the receiving terminal MCU chip is provided with a storage module, the storage module is provided with an original voice instruction storage module, a plurality of sets of original voice instructions are stored in the original voice instruction storage module, and each set of original voice instructions corresponds to a control instruction; the voice acquisition module is configured to collect and transmit audio signals to the voice chip, the voice chip converts a received audio signal into a digital instruction signal and sends it to the receiving terminal MCU chip, and the receiving terminal MCU chip compares and matches the received instruction with an original voice instruction stored in the storage module, and outputs a corresponding control instruction according to matching results.

2. The voice-controlled AI-based vehicle-mounted display system according to claim 1, wherein the RX control terminal further comprises a key module, and the key module is electrically connected to the host circuit board and configured for manual control.

3. The voice-controlled AI-based vehicle-mounted display system according to claim 1, wherein the storage module of the receiving terminal MCU chip is further provided with a newly added voice instruction storage module, and the newly added voice instruction storage module is configured to store newly added voice instructions collected by a user by means of the voice acquisition module and control instructions corresponding to newly added voice instructions; and after receiving a digital instruction signal converted by the voice chip, the receiving terminal MCU chip compares and matches the received instruction with an original voice instruction and a newly added voice instruction stored in the storage module simultaneously, and outputs a corresponding control instruction according to matching results.

4. The voice-controlled AI-based vehicle-mounted display system according to claim 1, wherein a microphone is used for the voice acquisition module, and an LCD display screen or an LED display screen is used for the display module.

5. The voice-controlled AI-based vehicle-mounted display system according to claim 1, wherein the RX control terminal further comprises a receiving terminal wireless connection chip, the receiving terminal wireless connection chip is electrically connected to the receiving terminal MCU chip, and the receiving terminal MCU chip is in communication connection with peripheral equipment by means of the receiving terminal wireless connection chip.

6. The voice-controlled AI-based vehicle-mounted display system according to claim 5, wherein one or more sets of TX terminals are further comprised, the TX terminal comprises a control circuit board, a transmitting terminal MCU chip, a transmitting terminal wireless connection chip, a camera drive circuit, and a camera, wherein the transmitting terminal MCU chip, the transmitting terminal wireless connection chip, and the camera drive circuit are arranged on the control circuit board, the transmitting terminal MCU chip, by means of a transmitting terminal, is in communication connection with the receiving terminal wireless connection chip of the RX control terminal, and the camera is electrically connected to the transmitting terminal MCU chip by means of the camera drive circuit.

7. The voice-controlled AI-based vehicle-mounted display system according to claim 6, wherein the transmitting terminal MCU chip is provided with an H.264 video compression module, and the receiving terminal MCU chip is provided with an MGPEG video decoding module.

8. The voice-controlled AI-based vehicle-mounted display system according to claim 6, wherein the TX terminal further comprises an infrared camera, and the infrared camera is electrically connected to the transmitting terminal MCU chip.

9. A control method for a voice-controlled AI-based vehicle-mounted display system, used for the voice-controlled AI-based vehicle-mounted display system according to claim 6, wherein the RX control terminal is provided with a code pairing key, and the TX terminal is provided with a code pairing mode and a code pairing LED lamp; and the control method comprises the following steps:
S100, powering on the RX control terminal, and powering on the display module of the RX control terminal for display;
S200, pressing and holding the code pairing key until the display module displays a word “Pairing” to enter the code pairing mode;
S300, powering on the TX terminal to enable the TX terminal to automatically enter the code pairing mode;
S400, flashing the code pairing LED lamp of the TX terminal for code pairing, wherein the RX control terminal, after successful code pairing, receives images captured by the TX terminal; and
S500, collecting and transmitting audio signals to the voice chip by means of the voice acquisition module, converting a received audio signal into a digital instruction signal by means of the voice chip and sending it to the receiving terminal MCU chip, comparing and matching the received instruction with a voice instruction stored in the storage module by means of the receiving terminal MCU chip, and outputting a corresponding control instruction according to matching results.

10. The control method for a voice-controlled AI-based vehicle-mounted display system according to claim 9, wherein voice trigger instructions are stored in the storage module of the receiving terminal MCU chip, and only when the receiving terminal MCU chip receives an instruction signal that matches a voice trigger instruction, a voice control mode can be activated.
